(19) United States
(12) Patent Application Publication
(10) Pub. No.: US 2015/0027382 A1
(43) Pub. Date: Jan. 29, 2015

(54) MODULAR PET PLAY STRUCTURE

(71) Applicant: INNOVATION PET, INC., Cedarpines Park, CA (US)

(72) Inventors: Jim Mc Cafferty, San Clemente, CA (US); Richard Ferris, Anaheim, CA (US)

(21) Appl. No.: 14/446,126

(22) Filed: Jul. 29, 2014

Related U.S. Application Data
(60) Provisional application No. 61/859,681, filed on Jul. 29, 2013.

(51) Int. Cl. A01K 15/02

(52) U.S. Cl. CPC A01K 15/025
USPC 119/707; 29/428

(57) ABSTRACT

Modular pet structure assemblies and related methods are disclosed. The modular pet structures have a base module with a plurality of connection joints for receiving other modules. The base can receive one or more than one vertical modules. The vertical module can attach to the base and includes at least one bi-directional movement mechanism having two spaced apart ends. The at least one bi-directional movement mechanism is configured to move when one of the ends is moved. For example, when a toy attached to one end is moved, a second toy attached to the other end moves in response thereto.

### FIELD OF ART

The device, system, and method described herein relate generally to pet toys, and more particularly to a pet toy providing linked movements when an end of the link is touched or grabbed. The device, system and method also relate to pet toys that can be configured into different shapes by physical manipulation.

### BACKGROUND

Pets, particularly cats, enjoy batting toys about. Pet amusement devices providing a contained area in which a toy may be batted, such as a vertical structure, are particularly desirable. Additionally, many cats are stimulated by the linked movements of objects.

### SUMMARY

Features of the present application include a pet amusement device that combines a toy on a vertical structure with linked movements of other toys. It is a further aspect of the present disclosure to provide such a pet amusement device that may be configured in a number of different ways in order to present a new play challenge for the pet.

A further feature of the present disclosure is a pet toy that is capable of providing linked movements with easily reconfigured shapes and arrangements. Movement of one toy in one location on the structure causes movement in another toy on a different part of the structure thereby stirring the pet's curiosity.

A still further feature of the present disclosure is a pet toy that is capable changing its configuration so as to appear new or novel to the pet. The toy may include edible materials, such as snacks and treats, which can independently keep the pet interested even after the edible material has been consumed. These needs are met by the present disclosure as described and claimed below.

The present disclosure can further include a modular pet structure assembly comprising: a base module comprising a plurality of connection joints; a vertical module attached to the base module, said vertical module comprising at least one bi-directional movement mechanism having two ends, said bi-directional movement mechanism comprising a first toy connected to a first end and a second toy connected to a second end; and wherein when one of the first toy and the second toy is moved, the other one of the first toy and the second toy reacts and moves.

The modular pet structure assembly, wherein the toys are connected to a corresponding receptacle at the ends with a detent.

The modular pet structure assembly, wherein the bi-directional movement mechanism can comprise an arm having two ends and at least one pivotable member at each end.

The modular pet structure assembly, wherein the bi-directional movement mechanism can comprise a switch and a motor.

The modular pet structure assembly can further comprise a plurality of ports on the base module for receiving two or more vertical modules.

The modular pet structure assembly can further comprise a leg having two leg sections attached to the base module to increase a base profile of the base module.

The modular pet structure assembly can further comprise a second vertical module and wherein a second base module is attached to the vertical module and the second vertical module.

The modular pet structure assembly can further comprise a second bi-directional movement mechanism located on the vertical module on an edge opposite the bi-directional movement mechanism.

The modular pet structure assembly wherein when the first toy moves in a first direction, the second toy can also move in the first direction.

The modular pet structure assembly wherein the vertical module can comprise a vertical center section located between two elongated outer sections; and wherein the vertical center section can comprise a replaceable cardboard.

The modular pet structure assembly wherein the vertical center section can sisal rope placed on a backing.

The modular pet structure assembly wherein the vertical module can comprise two spaced apart projections that project into the connection joints on the base module.

A further aspect of the present disclosure is a modular pet structure assembly comprising: a base module comprising a plurality of spaced apart connection joints; a vertical module comprising an end attached to the base module at one of the connection joints, said vertical module comprising a center section and two outer sections; a bi-directional movement mechanism having two ends located at one of the two outer sections, said bi-directional movement mechanism comprising a first toy connected to a first end and a second toy connected to a second end; and wherein when one of the first toy and the second toy is moved, the other one of the first toy and the second toy reacts and moves.

The modular pet structure assembly wherein the end of the vertical module can be a projection that projects into a bore.

The modular pet structure assembly can further comprise a cap attached to the two outer sections.

The modular pet structure assembly can further comprise a second bi-directional movement mechanism having two ends, and wherein a third toy is connected to a first end of the second bi-directional movement mechanism and a fourth toy is connected to a second end of the second bi-directional movement mechanism.

The modular pet structure assembly wherein the toys can be removable from the ends and can be attached interchangeably with any of the ends.

The modular pet structure assembly wherein the bi-directional movement mechanism can comprise a switch and a motor.

The modular pet structure assembly wherein the vertical center section can comprise a replaceable cardboard.

The modular pet structure assembly wherein the vertical center section can sisal rope placed on a backing.

The present disclosure is further directed to a method for assembling a modular pet structure assembly. The method can comprise the steps of snapping a vertical module into a connection joint located on a base module; said vertical module comprising a bi-directional movement mechanism having two ends including a first end and a second end; attaching a first toy at the first end and a second toy at the second end; pulling on the first toy and causing the second toy to move in response to movement of the first toy.

The method wherein the first toy can include a projection that projects into a bore at the first end.

### BRIEF DESCRIPTION OF THE DRAWINGS

These and other features and advantages of the present device, system, and method will become appreciated as the same becomes better understood with reference to the specification, claims and appended drawings wherein:

FIG. 1A is a perspective view of a pet play structure of in accordance with aspects of the present disclosure;

FIG. 1B is a top view of the modular pet play structure of FIG. 1A;

FIG. 1C is a side view of the pet play structure of FIG. 1A;

FIG. 1D is a rear view of the pet play structure of FIG. 1A;

FIG. 2A is a perspective view of an alternative pet play structure in accordance with aspects of the present disclosure;

FIG. 2B is a top view of the pet play structure of FIG. 2A;

FIG. 2C is a side view of the pet play structure of FIG. 2A;

FIG. 2D is a rear view of the pet play structure of FIG. 2A;

FIG. 3 is a cross-sectional side view of a yet another modular pet play structure provided in accordance with aspects of the present disclosure;

FIG. 4 is a cross-section of a portion of still yet another modular pet play structure of the present disclosure; and

FIG. 5 is a cross-section of a portion of yet another embodiment of a modular pet play structure of the present disclosure.

### DETAILED DESCRIPTION

The detailed description set forth below in connection with the appended drawings is intended as a description of the presently preferred embodiments of a modular pet play structure provided in accordance with aspects of the present device, system, and method and is not intended to represent the only forms in which the present device, system, and method may be constructed or utilized. The description sets forth the features and the steps for constructing and using the embodiments of the present device, system, and method in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

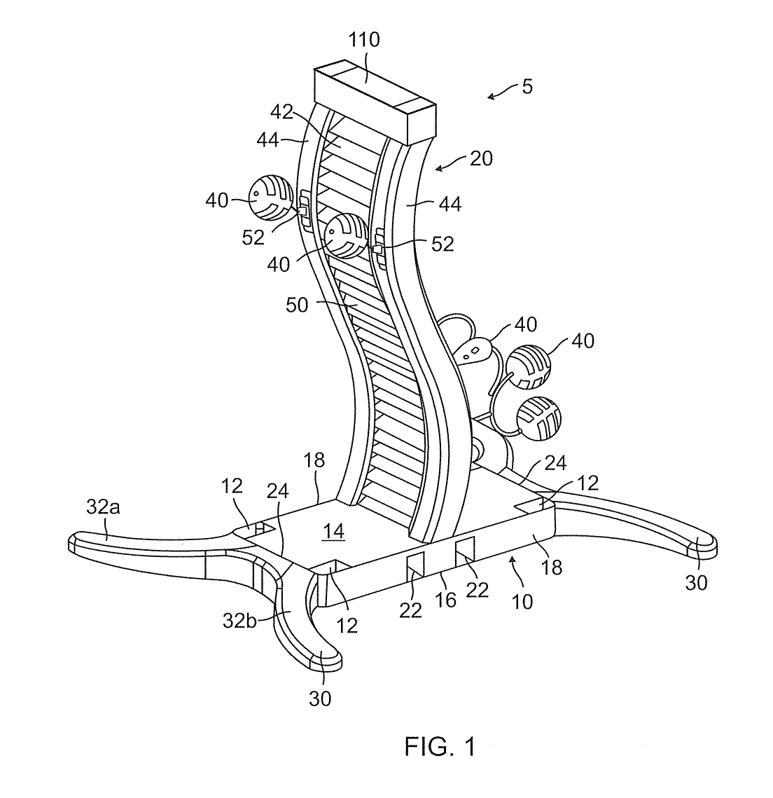

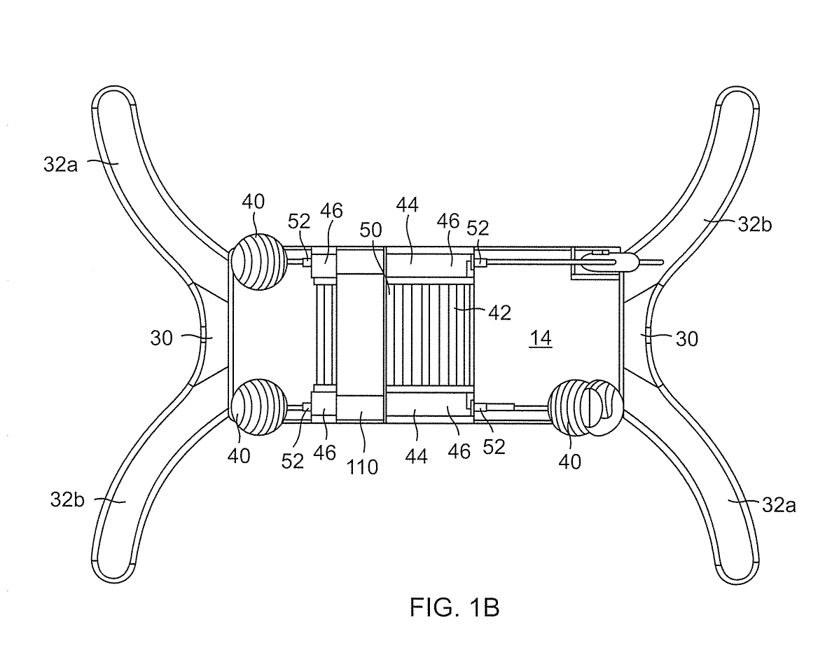

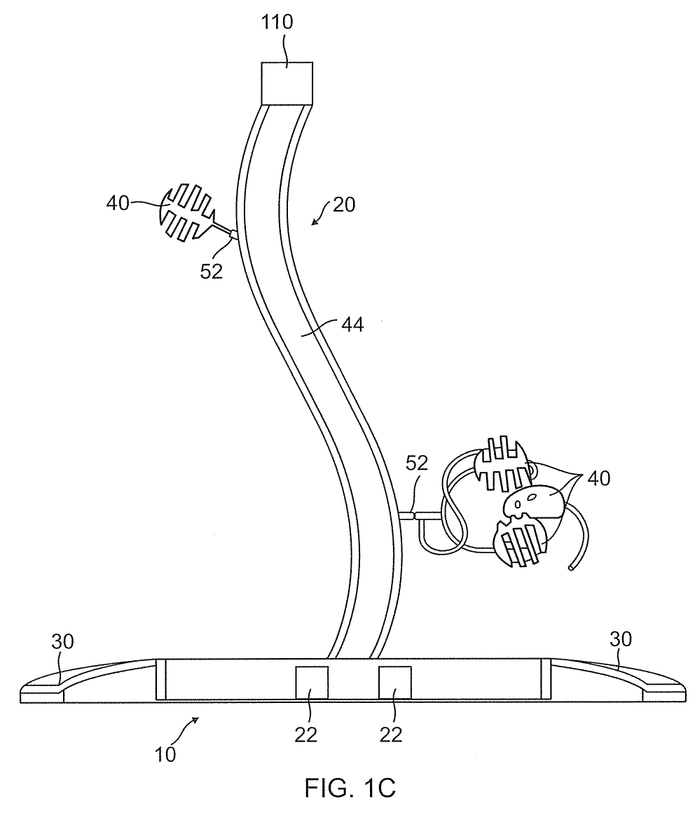

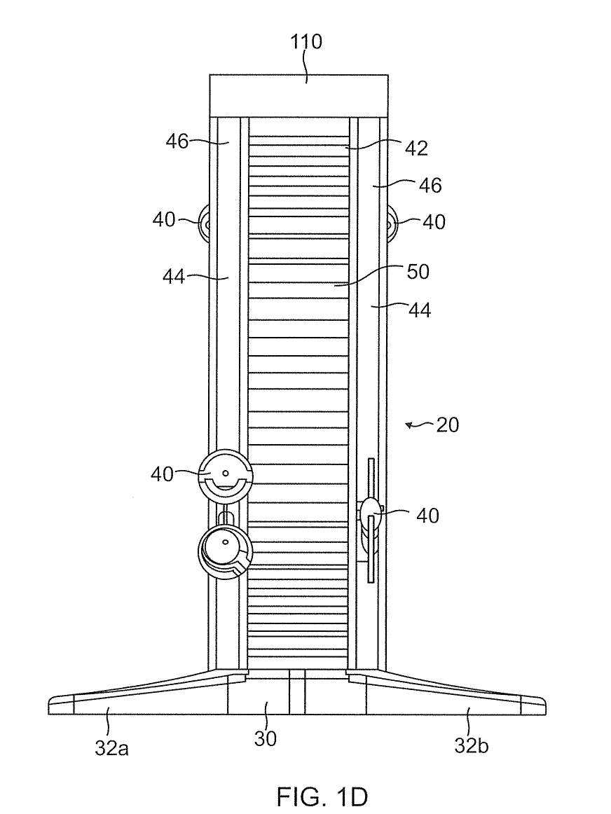

FIGS. 1A-1D show different views of a modular pet play structure 5 provided in accordance with aspects of the present devices, systems, and methods. The pet play structure 5 includes modules and attachments and can be re-configured. Several modules are shown in FIGS. 1A-1D including base modules 10 and frame modules 20. As the modules are mounted horizontally and vertically, the modules may alternatively be referred to as horizontal module 10 and vertical modules 20. Also shown are fixtures attached to the modules, which include legs 30 and pet toys 40.

In the embodiment shown, a single horizontal module 10 forms a base for the pet play structure 5. The horizontal module 10 is generally a rectangular parallelepiped, with the height generally less than half of the width or length. The thickness of the horizontal module can vary and can range from about 1 inch to about 4 inches. However, these dimensions are relative dimensions and exemplary only as the various modules can be sized and shaped differently. The horizontal module 10 includes a number of attachment ports or receptacles. As shown, the attachment ports are formed both vertically and horizontally into the horizontal module 10, such as through the upper surface 14 and side surface 18 of the horizontal module. The vertical ports 12 are generally rectangular in cross section and are formed through the depth of the horizontal modules 10, from the upper horizontal surface 14 to the bottom horizontal surface 16 to form through bores. In other examples, no openings are provided in the bottom horizontal surface 16 and the ports are not through bores. In the embodiment shown, there are six vertical ports 12, one in each corner, and two additional ports in a middle of each of a long side 18 of the horizontal module 10. In other embodiments, there may be as few as two or as many as 10 or more vertical ports in the horizontal module 10. As further discussed below, the ports 12 are configured to interact with corresponding features from other modules in order to assemble and configure the desired pet play structure 5.

The horizontal ports 22 are generally square in cross section and formed through the sides 18 of the horizontal module 10. Ports may also be incorporated on the short side 24 of the module. The openings of the horizontal ports 22 may be equal in size or dimension to the vertical ports 12 to form standard connecting joints. However, the sizes can vary to form non-standard joints. In the embodiment shown, each of the long sides 18 and each of the short sides 24 of the horizontal module 10 have a pair of horizontal ports 22. In other examples, the number can vary. As show in FIGS. 1A-1D, two legs 30 are attached at each end of the short side 24 of the horizontal module to a pair of the horizontal ports 22. For example, each leg 30 has a pair of projections that project into the ports 22 to engage the leg 30 to the module 10. The engagement can include a slight interference or a friction fit. Thus, in the embodiment shown, up to four pairs of legs 30 can be attached to add stability to the horizontal module 10 acting as a base for the modular pet play structure 5. In other embodiments, there may be as few as two pairs of horizontal ports 22 in a horizontal module 10, or as many as eight pairs or more in a horizontal module 10.

The ports 12, 22 are configured to accept a variety of attachments. The attachments may be other modules, including vertical modules 20, or other fixtures, such as toys or add-on features that expand the overall size of the pet play structure 5 with varying attractions, including reflective features, features that cause audible sound, and features that move, spin, or shake. The attachments may also be legs 30, which aid in stabilizing a horizontal module 10 used as a base, as discussed in more detail below. The ports 12, 22 may also accept attachments including individual or multiple pet toys 40.

In one example, the horizontal module is made from a plastic molded injection and has a slick plastic surface finish. As shown, the upper horizontal surface 14 of the horizontal module 10 is provided with a coating or inset material. For example, the surface can be covered with a carpet or carpet-like layer to entice pets (not shown) to play thereon, such as to roll or scratch their paws thereagainst. The bottom horizontal surface 16 of the horizontal module 10 may include materials (not shown) to increase friction, thereby preventing sliding. The materials may be attached to the bottom horizontal surface 16 in patterns, arrangements, or some defined intervals. Materials that may be used for reducing friction can include disk-shaped feet, rectangular strips, rectangular or square pads, or other rubber or tacky cushions.

The legs 30 are designed to increase the footprint of the horizontal module 10 acting as the base. The legs 30 add to the surface contact of the horizontal module 10 acting as the base in both width and length. The legs 30 may be formed as a horn-shape structure having two leg extensions 32a, 32b which extend away from the horizontal module as shown in FIGS. 1A-1D. In other embodiments, the legs 30 may be separately formed structures of roughly trapezoidal shape when viewed from above. The legs 30 include two lugs or projections (not shown) that engage a pair of horizontal ports 22 on each of the two short sides 18, 24 of the horizontal module 10.

The vertical module 20 of the modular pet play structure 5 is shown formed as a generally rectangular parallelepiped, similar to the horizontal modules 10. In other embodiments, such as that shown in FIGS. 1A-1D, the vertical module 20 may have a side profile that arcs in one or more directions back and forth across the vertical module's longitudinal axis to form an undulating surface feature. However, the overall shape of the vertical module 20 is not limited to any particular shape. The arcing in the embodiment of FIGS. 1A-1D is asymmetrical. In other embodiments, the arcing may be symmetrical. In still other embodiments the vertical modules may include straight sections set at angles to one another.

Each vertical module 20 includes a center section 42 and two outer sections 44 (FIG. 1D). The center section 42 can comprise a plastic planar surface having surface features incorporated thereon. In another example, the center section 42 comprises a replaceable two sided scratch pad 50, which may be made from cardboard box material or other durable materials that the pet may claw or scratch. The surface of the center material 42 may be smooth or may be creased to resemble slats. The two outer sections 44 along with the post cap 110 are formed in three sided “U” shapes that form the support structure for the vertical module 20. Two side sections 46 of the “U” shaped outer section 44 overlap the edges of the center section 42, creating the appearance of a single solid piece. In one example, the two outer sections 44 incorporate spaced side walls for receiving a respective edge of the center section so as to support the center section. In another example, the two outer sections 44 have bumps or other means, such as clamping surfaces, for pressing on the surfaces of the center section 42 to support the center section.

The vertical modules 20 may be separated into their component sections 42, 44 so that the center section 42 may be replaced when worn or damaged. In one embodiment, the center section 42 is formed from cardboard pieces with the same dimensions as a cross section along a longitudinal axis of the vertical module 20. With this construction, the pieces of a worn out center section 42 of the vertical module 42 can be replaced, eliminating the need to replace the entire center section 42. In other embodiments, the center section 42 may be formed by a single cardboard piece. In still other embodiments, other materials may be used, such as sisal rope placed on a backing. In some examples, one or more rigid posts may extend through the center section 42 and anchored to the horizontal or base module 10 with or without the outer sections 44. For example, rather than supporting the center section from the outer edges, the support mechanism can be provided centrally or internally of the center section 42.

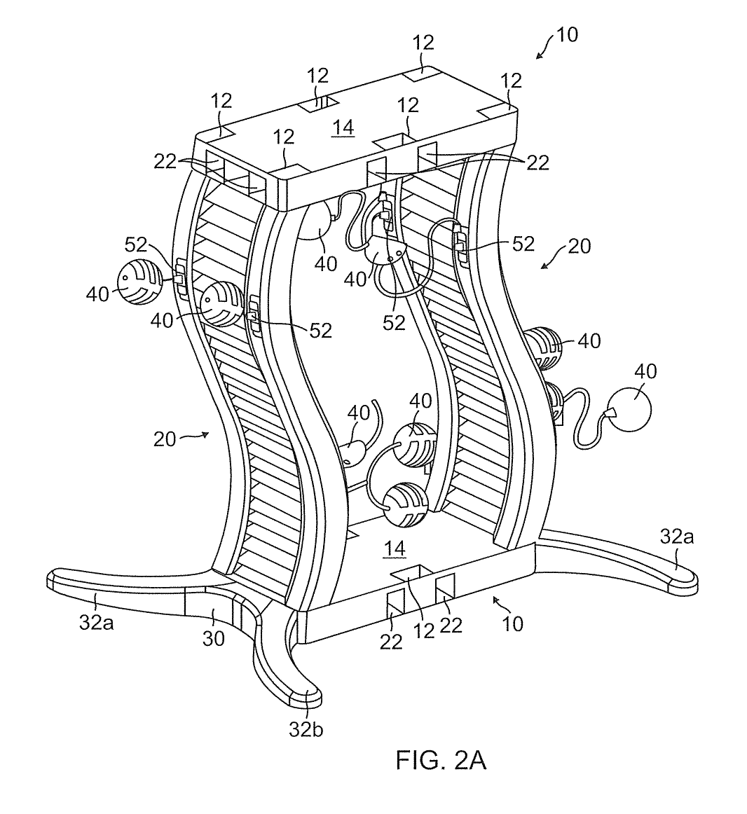

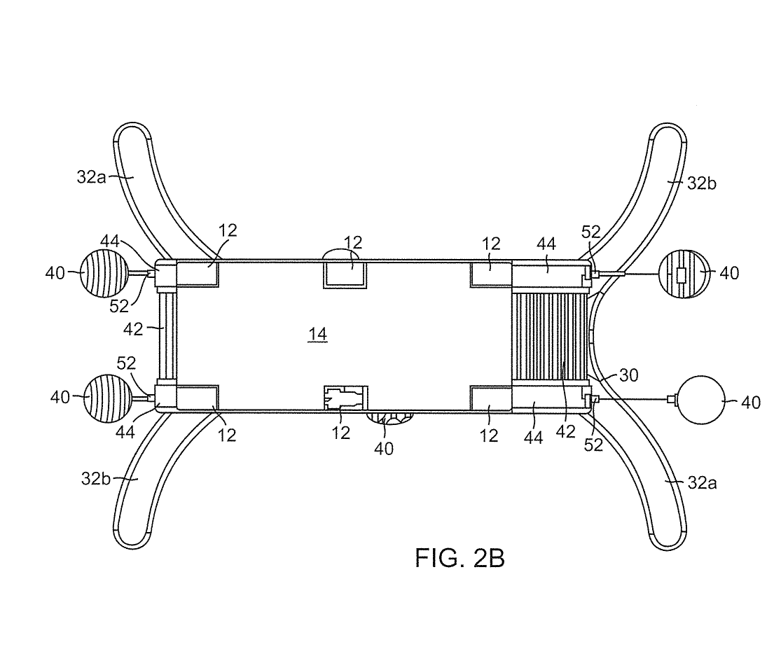

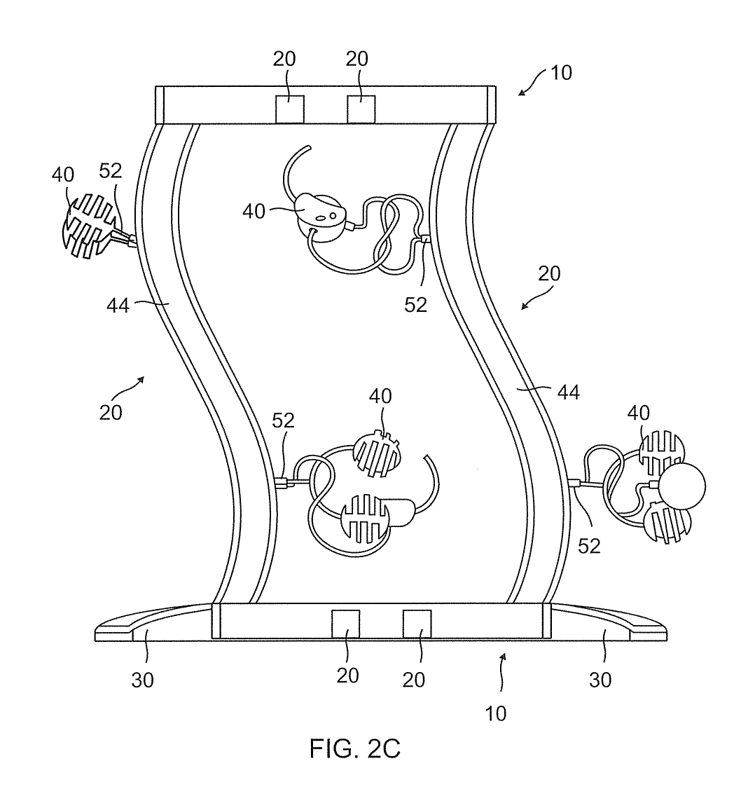

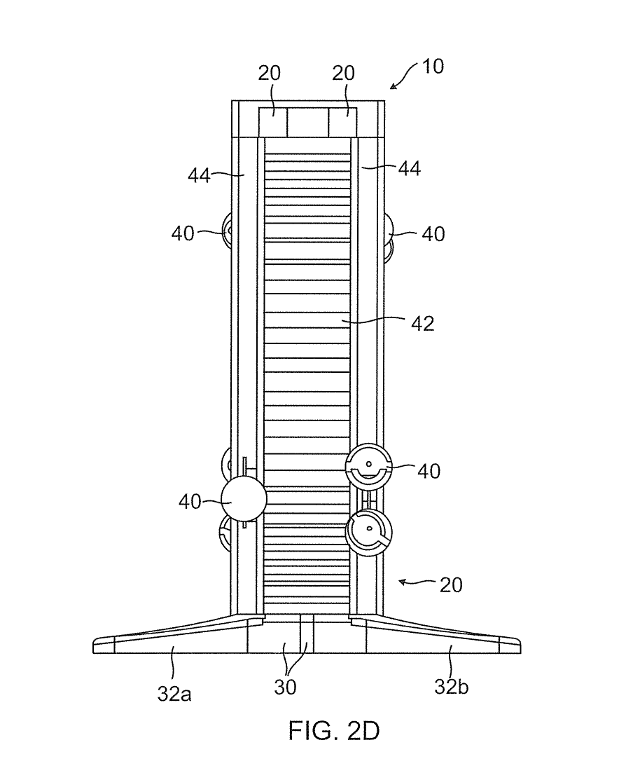

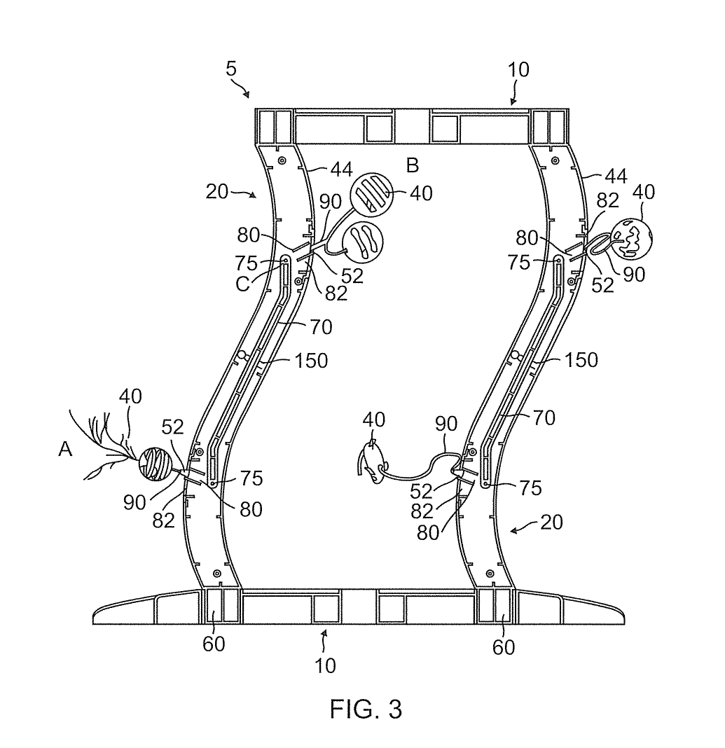

On each end of the vertical module 20, two lugs 60 (FIG. 3) extend longitudinally from the outer sections 44. As shown in FIG. 3, the lugs 60 are configured to friction fit or have an interference fit with the vertical ports 12 in the horizontal modules 10. As shown in FIGS. 1A-1D, the vertical module 20 may capped by a single post cap 110, which is sized and shaped to receive the lugs 60. As shown in FIGS. 2A-2D, when more than one vertical module 20 is used in a pet play structure 5, the vertical modules 20 may alternatively be capped by a horizontal module 10 or by two or more spaced apart post caps 110 (FIG. 1D).

Connection points 52 on the vertical modules 20 are configured to receive toys 40 in a removable arrangement. The toys may have one or more enlarged ends, such as a ball, a stuffed animal, or other inanimate object, attached to an elongated frame having a connection end. For example, the connection end can be a male projection, such as a male detent, for attaching to a bore, such as a socket or female detent. The connection points 52 can each include a female detent for receiving a corresponding male detent on the toy. Other engagement means for attaching toys to the modules are contemplated, including snap fittings and VELCRO®. The toys can vary in size, shape, and type. In the embodiments shown in FIGS. 1A-2D, there are four connection points 52, with two on each side of the vertical module 20. In other embodiments there may be as few as two connection points 52 or as many as 14 or more. Some of the connection points 52 may be fixed, and others may move, as discussed in more detail below. The pet play structure 5 may be adorned with any number of colors and indicia, including reflective tapes, bells and whistles, and pockets for storing items, such as toys and food. Further, while the toys are shown attached to the outer sections 44, in other embodiments, at least one of the toys is attached the center section 42.

FIG. 3 is a cross-sectional view of the modular pet play structure 5 in a two vertical module 20 configuration and two horizontal module 10 configuration. The vertical modules 10 are shown with pivot arms 70. The pivot arms 70 may also be called bi-directional arms, movable extended arms, or more broadly as bi-direction movement mechanism and even more broadly as multi-directional movement mechanism. The multi-directional movement mechanism is configured so that when one part of the mechanism is moved, it causes another part of the mechanism to move. When used with the present assembly, movement at one end of the mechanism by a pet will cause another end of the mechanism to move to attract the pet's attention and possibly a response. In some examples, movement at one end of the multi-directional movement mechanism can cause multiple other sections of the mechanism to move. When using an electro-mechanical device, parts of the multi-directional movement mechanism may not physically connect or connect via electrical wires or leads only.

The bi-directional arms 70 extend through a passage 150 near or at the middle of the bi-directional arm 70. The passage 150 may embody an aperture or an open channel for receiving the arm to ensure movement of the arm within the space provide by the passage. Each arm 70 has two ends and a connection joint 75 at each of the ends. An attachment arm 80 is connected to each joint 75, such as by detent or snap fit arrangement, including pin projecting into a bore. The attachment arms 80 are then connected to anchor points 52. In an example, each connection point 52 comprises a bore for receiving a stem or a projection from a removable fixture, such as a toy. The arrangement allows the toy to freely rotate about the bore provided at the connection point 52. The connection at the joint 75 between the pivot arm 70 and the attachment arm 80 on either end of the arm is freely rotatable and movable along an angular position. The attachment arms 80 or at least the connection points 52 extend through respective slots 82 in the outer sections 44 of the vertical modules 20. This allows the ends of each toy to easily snap into a corresponding connection point 52. Further, in the present embodiment, an anchor can be provided at each attachment arm 80 or at each connection point 52 so that the movement pivots about that anchor. As further discussed below, the bi-directional arm 70 can translate when moved but at least part of the movements at the two attachment arms 80 or the two anchor points are limited to a pivoting motion.

Toys 40 are mounted to the pivoting connection points 52 through a detent arrangement, with the male portion of the connector (not shown) on the end of the toy stem 90 and the female portion on the pivoting anchor point 52 attached to the end of the attachment arm 80. Each vertical post 20 may contain more than one pivoting swing arm 70. For example, one bi-direction arm 70 may be placed in each of the outer sections 44.

When a toy 40 attached to one of the pivoting anchor points 52 is manipulated, such as at A, the bi-directional arm 70 causes the toy 40 attached at the opposite end of the bi-directional arm 70, such as at B, to move in the same direction. For example, when a toy 40 and corresponding pivoting connection point 52 at A is levered downward, it lowers the attachment arm 80 at the end closest to the toy but raises the opposite end. This then causes the bi-directional arm 70 to raise and to also raise the end of the attachment arm 80 connected at the joint 75, shown as point C. As this point is raised, the other end of the attachment arm 80 held at the slot 82, such as by a pivoting pin, is pushed downwardly. This moves or pivots the connection point 52 downwardly and corresponding toy 40 at B to move downwardly. Thus, the two toys 40 attached to the same bi-directional arm 70 always move in opposition to the movement of the bi-directional arm 70 and in unison to each other. However, a person of ordinary skill in the art can readily adjust the connection joints so that the two toys move in opposition. For example, if the toy at A is lowered, then the toy at B is raised. This movement is meant to attract the pet's attention and to increase the play attractiveness of the modular pet play structure 5.

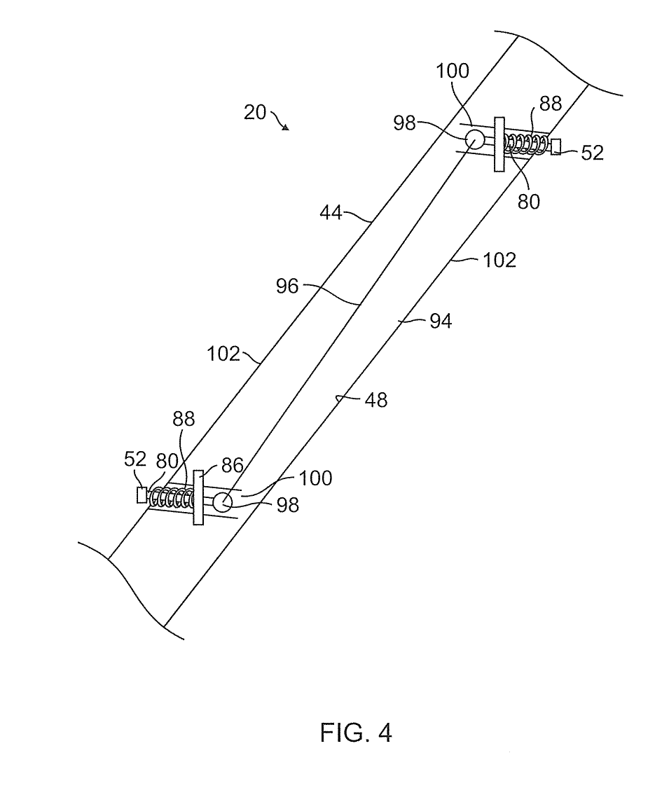

FIG. 4 is a partial cross-sectional view of an alternative movement mechanism provided in accordance with aspects of the present disclosure. In the present embodiment, the connection points 52 and attachment arms 80 do not pivot, but instead move laterally inward and outward from the vertical module 20. In the present embodiment, the attachment arm 80 includes a radially extending flange 86. A spring 88 is partially compressed between an interior surface 48 of the outer section 44 of the vertical module 20 and the radially extending flange 86. The two attachment arms 80 are connected in an interior 94 of the outer section 44 by a non-rigid member 96, such as a cable, a cord, or a string. When one toy and a corresponding anchor point are pulled laterally away from the vertical module, a pair of bosses 98 attached to the attachment arm 80 slide in a track 100 formed on the interior surface 48 of the outer section 44, and the non-rigid member 96 causes the connection point 52 and corresponding toy 40 on the other end of the non-rigid member 96 to move toward an exterior surface 102 of the vertical module 20. When the tension is released on the first toy 40 (FIG. 2A), the springs 88 on the attachment arms 80 return the toys 40 to an equilibrium state.

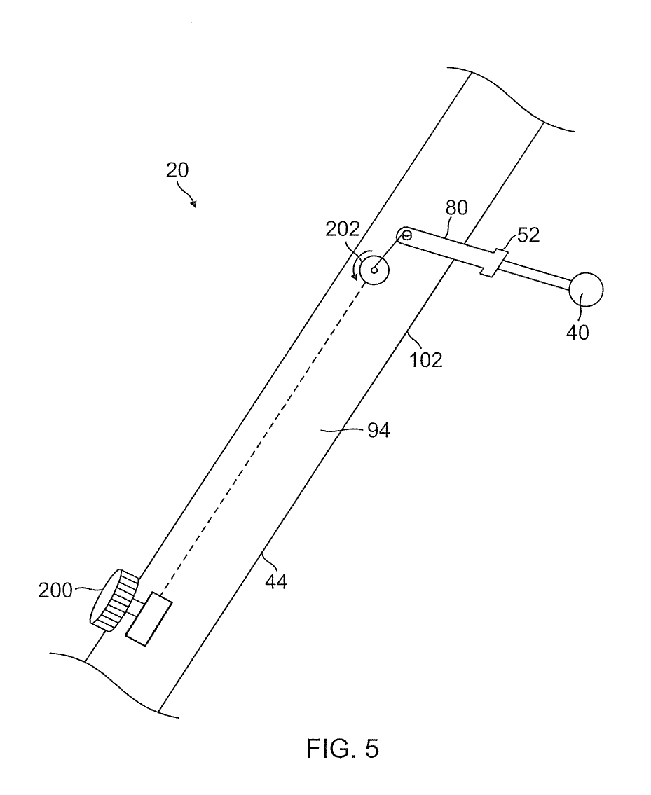

FIG. 5 is a partial cross-sectional view of another alternative movement mechanism provided in accordance with further aspects of the present disclosure. In the present embodiment, an activator 200, such as a switch, button, or sensor is placed on the exterior surface 102 of a vertical module 20. The activator 200 is connected directly or indirectly, as is well known in the art, to an electro-mechanical device, which may also be called an operator 202, such as a servo motor. The activator may be lighted or flashed to attract reaction from a pet. Alternatively, a toy may be connected to the activator 200. When the activator 200 is activated by pressing, switching, or triggering or by pulling or tugging on a toy connected to the activator, the activation causes the operator 202 to function in a predetermined manner. In one example, an activator 200, which is in this case, a button, is depressed. The pressing of the activator 200 causes the operator 202, a servo motor placed in the interior 94 of an outside section 44 of the vertical module 20, to rotate as shown by the arrow and pivot an attachment arm 80 on the opposite end and side of the vertical module 20. The toy attached to the connection point 52 on the attachment arm 40 moves correspondingly.

In accordance with still further aspects of the present disclosure, cat snacks and/or treats may be added to one of the toys or be used for one of the toys disclosed herein. Pockets or slots may also be incorporated for holding or storing snacks, treats, and/or food. In another example, the toy stem 90 is configured with a 90 degree turn such that when the toy is attached to an anchor point, the toy will be visible from the opposite side of the vertical module. Thus, a pet on one side will be able to see the reaction caused by the activation.

The toys discussed herein may also be used with suction cups, such as ones that are pressed against a smooth surface and stick to the surface via vacuum. At the opposite end of the suction cup, a bore may be provided so that the male end of the toy can attach thereto. Thus, an aspect of the present disclosure is further understood to include a modular pet structure, such as the structures disclosed elsewhere herein, wherein a toy having a male end or projection is engageable to a socket and wherein the toy is then useable with a suction cup having a bore for receiving the male end of the toy.

Although limited embodiments of the modular pet play structure assemblies and their components have been specifically described and illustrated herein, many modifications and variations will be apparent to those skilled in the art. For example, the various modular pet play structures may incorporate alternate forms of pet toys, etc. Furthermore, it is understood and contemplated that features specifically discussed for one modular pet play structure embodiment may be adopted for inclusion with another modular pet play structure embodiment, provided the functions are compatible. Accordingly, it is to be understood that the modular pet play structure assemblies and their components constructed according to principles of the disclosed device, system, and method may be embodied other than as specifically described herein. The disclosure is also defined in the following claims.

What is claimed is:

1. A modular pet structure assembly, comprising:
a base module comprising a plurality of connection joints;
a vertical module attached to the base module, said vertical module comprising at least one bi-directional movement mechanism having two ends, said bi-directional movement mechanism comprising a first toy connected to a first end and a second toy connected to a second end; and
wherein when one of the first toy and the second toy is moved, the other one of the first toy and the second toy reacts and moves.

2. The modular pet structure assembly of claim 1, wherein the toys are connected to a corresponding receptacle at the ends with a detent.

3. The modular pet structure assembly of claim 1, wherein the bi-directional movement mechanism comprises an arm having two ends and at least one pivotable member at each end.

4. The modular pet structure assembly of claim 1, wherein the bi-directional movement mechanism comprises a switch and a motor.

5. The modular pet structure assembly of claim 1, further comprising a plurality of ports on the base module for receiving two or more vertical modules.

6. The modular pet structure assembly of claim 1, further comprising a leg having two leg sections attached to the base module to increase a base profile of the base module.

7. The modular pet structure assembly of claim 1, further comprising a second vertical module and wherein a second base module is attached to the vertical module and the second vertical module.

8. The modular pet structure assembly of claim 1, further comprising a second bi-directional movement mechanism located on the vertical module on an edge opposite the bi-directional movement mechanism.

9. The modular pet structure assembly of claim 1, wherein when the first toy moves in a first direction, the second toy also moves in the first direction.

10. The modular pet structure assembly of claim 1, wherein the vertical module comprises a vertical center section located between two elongated outer sections; and wherein the vertical center section comprises a replaceable cardboard or sisal rope placed on a backing.

11. The modular pet structure assembly of claim 1, wherein the vertical module comprises two spaced apart projections that project into the connection joints on the base module.

12. A modular pet structure assembly, comprising:
a base module comprising a plurality of spaced apart connection joints;
a vertical module comprising an end attached to the base module at one of the connection joints, said vertical module comprising a center section and two outer sections;
a bi-directional movement mechanism having two ends located at one of the two outer sections, said bi-directional movement mechanism comprising a first toy connected to a first end and a second toy connected to a second end; and
wherein when one of the first toy and the second toy is moved, the other one of the first toy and the second toy reacts and moves.

13. The modular pet structure assembly of claim 12, wherein the end of the vertical module is a projection projecting into a bore.

14. The modular pet structure assembly of claim 12, further comprising a cap attached to the two outer sections.

15. The modular pet structure assembly of claim 12, further comprising a second bi-directional movement mechanism having two ends, and wherein a third toy is connected to a first end of the second bi-directional movement mechanism and a fourth toy is connected to a second end of the second bi-directional movement mechanism.

16. The modular pet structure assembly of claim 15, wherein the toys can be removable from the ends and can be attached interchangeably with any of the ends.

17. The modular pet structure assembly of claim 12, wherein the bi-directional movement mechanism comprises a switch and a motor.

18. The modular pet structure assembly of claim 12, wherein the vertical center section comprises a replaceable cardboard or sisal rope placed on a backing.

19. A method for assembling a modular pet structure assembly comprising:
snapping a vertical module into a connection joint located on a base module; said vertical module comprising a bi-directional movement mechanism having two ends including a first end and a second end;
attaching a first toy at the first end and a second toy at the second end;
pulling on the first toy and causing the second toy to move in response to movement of the first toy.

20. The method of claim 19, wherein the first toy has a projection that projects into a bore at the first end.
